(19) United States
(12) Patent Application Publication
(10) Pub. No.: US 2025/0232786 A1
(43) Pub. Date: Jul. 17, 2025

(54) ENHANCED USER INTERFACES FOR PARALINGUISTICS

(71) Applicant: Microsoft Technology Licensing, LLC, Redmond, WA (US)

(72) Inventors: Andréa BRITTO MATTOS LIMA, Sao Paulo (BR); Weiwei YANG, Seattle, WA (US); Spencer FOWERS, Duvall, WA (US); Amber Dawn HOAK, Silverdale, WA (US); David A. TITTSWORTH, Gig Harbor, WA (US)

(73) Assignee: Microsoft Technology Licensing, LLC, Redmond, WA (US)

(21) Appl. No.: 18/412,133

(22) Filed: Jan. 12, 2024

(51) Int. Cl. G10L 25/63; G06T 13/40; G10L 15/22

(52) U.S. Cl. CPC G10L 25/63; G06T 13/40; G10L 15/22

(57) ABSTRACT

Generative artificial intelligence (AI) agents can output simulated paralinguistic data. AI can also be used to infer paralinguistic data using sensors that detect contextual cues from users. Paralinguistic systems and methods explained herein involve presenting paralinguistic data (whether simulated or inferred) to a user concurrently with verbal data (e.g., words) in real time during a live interaction with an AI agent and/or another user in an intuitive manner. These concepts include multiple representations of paralinguistic data that are appropriate for various output channels, depending on the mode of interaction. The paralinguistic systems enable the user to have a better understanding of the responses from the AI agent, avoid misunderstanding, and better use the AI agent to roleplay mock conversations. These concepts also enable the user to be more aware of her own contextual cues as well as contextual cues being exhibited by other users.

### BACKGROUND

Generative artificial intelligence (AI) can generate a response (e.g., texts, images, or other media) that includes entirely new content that is similar to the training data but with some degree of novelty. A large language model (LLM) is a type of generative AI. LLMs are powerful neural networks that generate natural language with demonstrated value across a wide range of domains.

### SUMMARY

The concepts described herein relate to presenting paralinguistic data to users. Linguistics data (or verbal data) includes verbal meanings, whether spoken words (e.g., audio) or written words (e.g., text). Paralinguistic data includes a wide range of contextual data, that is, unspoken cues, such as facial expressions, body language, vocal intonations, affective states, cognitive states, etc. Two main examples of applying these concepts include presenting simulated paralinguistic data associated with a generative AI agent, and presenting inferred paralinguistic data associated with a human user. Seamlessly conveying paralinguistic data, in combination with linguistic data, in real time during a live conversation (whether with an AI agent or with other people, or both) enhances the experience, facilitates communication, and avoids misunderstanding.

### BRIEF DESCRIPTION OF THE DRAWINGS

The detailed description below references the accompanying figures. The use of similar reference numbers in different instances in the description and the figures may indicate similar or identical items. The example figures are not necessarily to scale.

FIG. 1 illustrates an example paralinguistic system, consistent with some implementations of the present concepts.

FIG. 2 illustrates an example use of sensors, consistent with some implementations of the present concepts.

FIG. 3 illustrates example output channels for paralinguistic data, consistent with some implementations of the present concepts.

FIG. 4 illustrates example visual coding representations of paralinguistic data, consistent with some implementations of the present concepts.

FIG. 5 illustrates example emoji and percentage representations of paralinguistic data, consistent with some implementations of the present concepts.

FIG. 6 illustrates example sensory modalities associated with paralinguistic data, consistent with some implementations of the present concepts.

FIGS. 7A and 7B illustrate example paralinguistic data associated with text tokens, consistent with some implementations of the present concepts.

FIG. 8 illustrates example paralinguistic data presented as a video overlay, consistent with some implementations of the present concepts.

FIG. 9 illustrates an example computer environment, consistent with some implementations of the present concepts.

### DETAILED DESCRIPTION

### Technological Problems and Solutions

Automatically generated responses from some AI agents, which are output in response to prompts from users, can include simulated paralinguistic data in addition to conventional verbal data. Such simulated paralinguistic data is designed to convey human-like characteristics, such as affective states. Thus, there is a need to present paralinguistic data associated with AI agents to human users in an effective, seamless, and user-friendly manner such that conversations between human users and AI agents are more natural. The concepts explained below set forth example representations of paralinguistic data and example interfaces for presenting and conveying simulated paralinguistic data associated with AI agents to users in real time.

Additionally, verbal prompts input by human users can be augmented by paralinguistic data inferred by machine-learning models, such that the augmented prompts are input to AI agents. However, it is possible that the machine-learning models may incorrectly infer the paralinguistic cues exhibited by human users. Such inaccuracies can cause AI agents to misunderstand or misinterpret the human users' prompts and return responses that are irrelevant or inappropriate. Furthermore, in some circumstances, the user may fail to pick up on other users' paralinguistic cues, especially when conversing via a videoconference rather than in person. Also, the user may not have enough self-awareness to be conscious of the paralinguistic cues that she herself is exhibiting to the AI agent or to other users. To combat these problems, the concepts described below present example representations and interfaces for presenting and conveying inferred paralinguistic data associated with human users. That is, a user can be informed about her own inferred paralinguistic data and/or other users' inferred paralinguistic data in real time. Thus, the user is made aware of how her own paralinguistic cues are being interpreted by the AI agent and also is made aware of the paralinguistic data associated with herself and/or other users.

### Systems

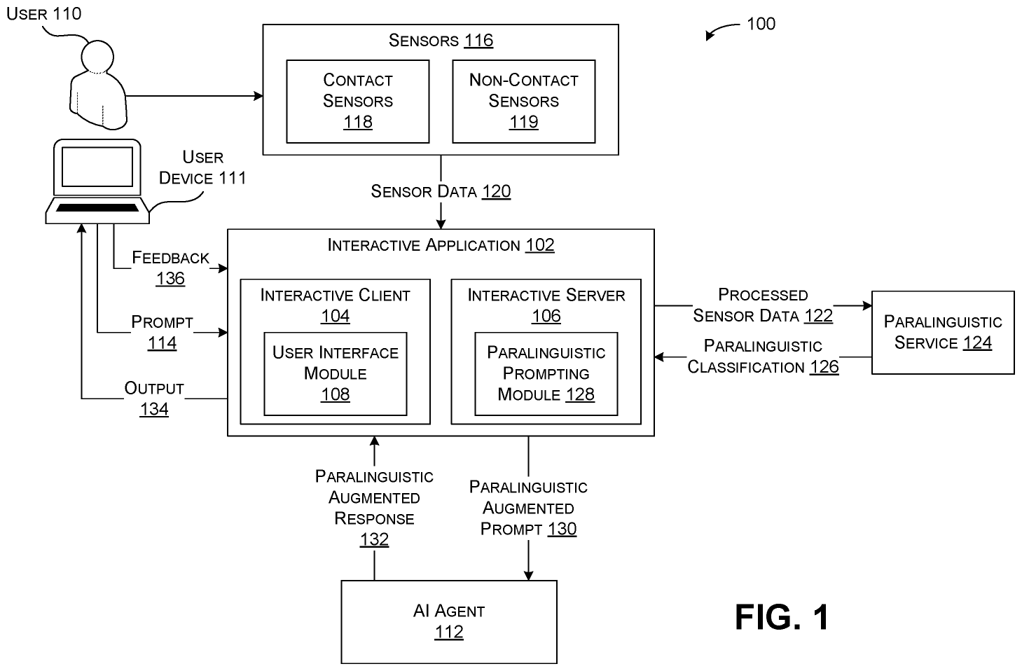

FIG. 1 illustrates an example paralinguistic system 100, consistent with some implementations of the present concepts. FIG. 1 includes a high-level architectural diagram of some components of the paralinguistic system 100. These example components can be implemented in hardware and/or software, on a common device or on different devices. The number of the components, the types of components, and the conceptual division or separation of the components in FIG. 1 are not meant to be limiting. An overview of the concepts described herein will be explained in connection with FIG. 1. Additional details will be provided below in connection with subsequent figures.

In one example implementation, the paralinguistic system 100 includes an interactive application 102. The interactive application 102 includes an interactive client 104 and an interactive server 106. The interactive client 104 includes a user interface module 108 for facilitating the interaction (e.g., a conversation) among a user 110, an AI agent 112, and potentially other users. Any communications to and from the user 110, described herein, may be conducted through a user device 111.

In an example interaction between the user 110 and the AI agent 112, the user interface module 108 receives a prompt 114 from the user 110. The prompt 114 can be received via text or any other mode or modes of input, such as speech or sign language. That is, the prompt 114 may be multi-modal. The prompt 114 can be received using one or more input devices, such as a keyboard, touchscreen, microphone, camera, etc. In one implementation, non-text inputs are converted to text that can be provided to the AI agent 112. For example, audio input is converted to text using speech recognition technology. The prompt 114 can be associated with metadata, such as timestamps and the identity of the user 110 who input the prompt 114.

Consistent with some implementations of the present concepts, the paralinguistic system 100 includes one or more sensors 116. With the user's permission and approval, the sensors 116 can read and detect a wide variety of contextual data about the user 110 using various sensory modes. In one implementation, the sensors 116 can be conceptually categorized into contact sensors 118 (or physical sensors) and non-contact sensors 119 (or remote sensors). The contact sensors 118 read data about the user 110 using sensors that physically contact the body of the user 110, whereas the non-contact sensors 119 read data about the user 110 using sensors that do not contact the body of the user 110.

Consistent with the present concepts, the sensors 116 detect one or more types of audio, video, physiological, cognitive (e.g., cognitive load, affective state, stress, and attention), and/or environmental signals that have a bearing on the paralinguistic state of the user 110. The sensors 116 can include brain-computer interfaces (BCIs). The present concepts do not contemplate any limitation in the kinds of sensors (i.e., sensory modalities) that can be used in the paralinguistic system 100. The more variety of sensors that are employed, the more holistic picture of the state of the user 110 can be ascertained, which would enable the AI agent 112 to be more context-aware and empathic, thereby respond with more relevant and appropriate responses.

In some implementations of the present concepts, the sensors 116 collect and send sensor data 120 to the interactive server 106. The sensor data 120 can include timestamps and the identity of the user 110. In one implementation, the interactive server 106 processes the sensor data 120 to generate processed sensor data 122. And then, the interactive server 106 sends the processed sensor data 122 to a paralinguistic service 124.

The sensor data 120 can be processed in many ways. For example, audio data can be normalized and denoised. If there are multiple voices in the audio data, the voice belonging to the user 110 can be isolated. Video data can have the colors normalized. If there are multiple faces in the frame, the face belonging to the user 110 can be recognized. Heart rate data can undergo certain preprocessing.

Any one or more of the sensors 116, the interactive server 106, and/or the paralinguistic service 124 can perform the processing of the sensor data 120. Alternatively, sensor data processing services (not pictured in FIG. 1) can be called to clean and pre-process the sensor data 120 in order to obtain the processed sensor data 122. For example, the interactive server 106 may conceptually be in an orchestration layer, and the sensor data processing services may be in a data processing layer. The interactive server 106 makes appropriate calls to services in the data processing layers (e.g., an audio processor, a video processor, etc.) depending on the types of sensor data available.

Consistent with the present concepts, the paralinguistic service 124 takes the processed sensor data 122 and determines a paralinguistic classification 126 associated with the user 110 in real time. In some implementations, the paralinguistic classification 126 can include one or more emotion categories. For example, the set of emotion categories can include anger, happiness, embarrassment, shame, surprise, confidence, pride, depression, fear, anxiety, love, satisfaction, envy, hate, compassion, frustration, sadness, disgust, guilt, boredom, interest, annoyance, loneliness, jealousy, disappointment, dejected, pity, shyness, awe, joy, relief, contempt, hope, elation, pride, neutral, etc. The paralinguistic service 124 can use rule-based models and/or machine-learning models to detect the paralinguistic classification 126 associated with the user 110 based on the processed sensor data 122. For example, the paralinguistic service 124 can include machine-learning model software that can extract and predict the affective states (e.g., emotional sentiments) of the user 110 based on cognitive data (e.g., electroencephalogram (EEG) data), physiological data (e.g., heart rate, perspiration rate, body temperature, etc.), audio data (e.g., pitch, intonation, volume, speed, etc.), video data (e.g., facial expressions, pupil dilation, arm gestures, etc.), and/or environmental data (e.g., ambient temperature, background noise, etc.). The paralinguistic service 124 outputs the paralinguistic classification 126 in real time to the interactive server 106. For example, the paralinguistic classification 126 includes paralinguistic tokens, which can augment the verbal tokens in the prompt 114. The paralinguistic classification 126 can include timestamps based on the timestamps included in the sensor data 120. The paralinguistic classification 126 can also include the identity of the user 110.

In some implementations, the interactive server 106 includes a paralinguistic prompting module 128. The paralinguistic prompting module 128 augments the prompt 114 based on the paralinguistic classification 126 to generate a paralinguistic augmented prompt 130, and then feeds the paralinguistic augmented prompt 130 to the AI agent 112. The paralinguistic prompting module 128 includes a prompt generation engine that can use rule-based algorithms and/or machine-learning models to generate the paralinguistic augmented prompt 130.

The AI agent 112 can be uni-modal (e.g., accepts and generates only text) or multi-modal (e.g., accepts and generates text, images, audio, and/or video). If the AI agent 112 has been designed and trained to accept the paralinguistic classification 126 that is output from the paralinguistic service 124, then the paralinguistic prompting module 128 can simply provide the prompt 114 and the paralinguistic classification 126 together as the paralinguistic augmented prompt 130. Alternatively, where the AI agent 112 is not designed to accept and understand the paralinguistic classification 126 in the format provided by the paralinguistic service 124, the paralinguistic prompting module 128 translates the paralinguistic classification 126 into a format that the AI agent 112 can accept and understand. For example, the paralinguistic prompting module 128 can convert the paralinguistic classification 126 into additional words (i.e., tokens) and/or emojis that are added to the prompt 114 to generate the paralinguistic augmented prompt 130.

As a result, the paralinguistic augmented prompt 130 includes contextual cues about the emotional state of the user 110 that were not included in the prompt 114. Accordingly, the paralinguistic system 100 seamlessly integrates the contextual data (e.g., the user's sentiments and intentions), which is not captured by the prompt 114 alone, into the paralinguistic augmented prompt 130. As such, the richness and subtleties of human communication are provided to the AI agent 112, and the AI agent 112 becomes aware of the context (e.g., emotion, intent, attitude, purpose, etc.) behind the words in the prompt 114.

In one implementation, the AI agent 112 simulates its own paralinguistic data. For example, the AI agent 112 can emulate (i.e., mirror) the emotions of the user 110. If the user 110 is experiencing sadness, then the AI agent 112 can simulate sadness as well to be compassionate, sympathetic, and comforting to the user 110. The AI agent 112 can also simulate uplifting emotions if the user 110 is sad, simulate enthusiasm when the user 110 is excited, or simulate calmness when the user 110 is upset. In another example, the AI agent 112 can simulate emotions in response to a command from the user 110. If the user 110 prompts the AI agent 112 to roleplay a mean boss, then the AI agent 112 can simulate anger and contempt. The AI agent 112 outputs a paralinguistic augmented response 132 that includes the simulated paralinguistic data. Thus, the paralinguistic augmented response 132 includes verbal data (e.g., textual response) augmented with simulated paralinguistic data (e.g., non-verbal contexts). For example, the paralinguistic augmented response 132 includes verbal tokens (e.g., word tokens) as well as paralinguistic tokens. In one implementation, the paralinguistic augmented response 132 includes a JavaScript Object Notation (JSON) array that pairs emotion categories and corresponding values: {‘neutral’: 0.1, ‘calm’: 0.0, ‘happy’: 0.6, ‘sad’: 0.0, ‘angry’: 0.2, ‘fearful’: 0.2, ‘disgust’: 0.0, ‘surprised’: 0.4}. The values can be formatted in many ways (e.g., decimals or percentages; positive or negative; normalized or not; etc.). In an alternative implementation, the paralinguistic augmented response 132 includes a set of emojis that represent a collection of emotions.

In one implementation, the interactive application 102 receives the paralinguistic augmented response 132 from the AI agent 112, and the user interface module 108 presents the paralinguistic augmented response 132 to the user 110 via an output 134 (or the user interface module 108 transmits the output 134 to the user device 111 for presentation to the user 110). The output 134 can include verbal data and/or paralinguistic data. For example, the user interface module 108 parses the paralinguistic augmented response 132 (which includes textual response and simulated paralinguistic data from the AI agent 112) and generates the output 134 to be presented to the user 110 using appropriate output channels.

Various output channels are possible, including text, graphical user interface (GUI), speech audio, video, avatar, robotic interface, etc. Thus, the output 134 can include multi-modal data. For example, where the output 134 includes text data, the output 134 can be rendered on a text display, such as a chat window. Where the output 134 includes emojis, the output 134 can be rendered on a GUI, such as on a display screen. Where the output 134 includes audio data, the output 134 can be played via a speaker. Example output channels will be explained further below in reference to subsequent figures.

In one implementation, the user interface module 108 uses a language translation module to translate the prompt 114 and/or the paralinguistic augmented response 132 to the appropriate language. The language translation module can automatically translate when the user 110 and the AI agent 112 (or other users) are communicating in different languages.

Moreover, the paralinguistic system 100 presents the user's own inferred paralinguistic data to the user 110. In one implementation, the user interface module 108 generates the output 134 to include paralinguistic data associated with the user 110 based on the paralinguistic classification 126. For example, a representation of the paralinguistic classification 126 is presented to the user 110 concurrently with the prompt 114. In an example implementation, the timestamp in the paralinguistic classification 126 and the timestamp in the prompt 114 can be used to synchronize the concurrent presentation of the paralinguistic classification 126 and the prompt 114 to the user 110. Accordingly, the user 110 is made aware of her own contextual cues and how the paralinguistic service 124 is interpreting them.

Further, the paralinguistic system 100 presents paralinguistic data associated with other users to the user 110, with the approval of the other users. For example, the paralinguistic service 124 infers paralinguistic classifications associated with other users, and the user interface module 108 generates the output 134 to include the inferred paralinguistic data associated with other users to be presented to the user 110. Accordingly, where the user 110 is interacting with another user or with multiple other users, the user 110 is made aware of the paralinguistic classifications associated with the other users, as determined by the paralinguistic service 124. The paralinguistic data associated with the user 110 or other users can be presented using similar output channels as the paralinguistic data associated with the AI agent 112.

In one implementation, real-time paralinguistic data is presented to the user 110 throughout the interaction. For example, paralinguistic data is continually or periodically updated and presented to the user 110 as the sensors 116 continually or periodically provide the sensor data 120 as time progresses throughout the interaction. Additionally or alternatively, paralinguistic data can be updated and presented to the user 110 in response to event-based triggers (e.g., the sensor readings change by a certain threshold). Additionally or alternatively, the user 110 requests paralinguistic data or requests updated paralinguistic data. In some scenarios, paralinguistic data accompanies (the beginning, middle, or end of) the verbal data when presented to the user 110 during the conversation. In other scenarios, paralinguistic data is presented to the user 110 even without any verbal data (e.g., where the AI agent 112 or another user exhibits emotions during a silent pause without any words).

In some implementations, the interactive application 102 receives feedback 136 from the user 110. The user 110 can provide the feedback 136 on any aspect of the interaction involving the AI agent 112 and/or other users. For example, the user 110 can provide the feedback 136 on the quality, accuracy, relevance, or propriety of the output 134, including the verbal response from the AI agent 112, the paralinguistic data associated with the AI agent 112, the paralinguistic data associated with the user 110, or the paralinguistic data associated with another user. For instance, if the user 110 is chatting with the AI agent 112, hoping for an uplifting, encouraging, and cheerful response, but instead receives a gloomy, dismal, and sorrowful response, the user 110 can provide the feedback 136 that indicates a negative rating. If the output 134 presents that the paralinguistic service 124 has detected that the user 110 is sad when, in fact, the user 110 is happy, the user 110 can provide the feedback 136 that indicates a negative rating. Alternatively, the feedback 136 can include a positive rating. Both positive and negative ratings can be used as validating reinforcements or corrective reinforcements to further train, fine tune, and/or personalize the machine-learning models in the paralinguistic service 124 and/or the AI agent 112.

That is, the feedback 136 can be used to improve the AI agent 112, for example, re-train or further train generally for all users or train to develop personalized models for the user 110. The feedback 136 can help the AI agent 112 to provide better responses in the future with respect to both the verbal responses and paralinguistic responses. The feedback 136 can serve as a continuous loop of feedback about the effectiveness of the paralinguistic augmented response 132 from the AI agent 112 in response to the prompt 114 from the user 110. This feedback loop can improve the AI agent's ability to personalize the responses over time. The assessment of the AI agent's responses can be made manually by the user 110 (e.g., the user interface includes voting buttons for the user 110 to evaluate each response during a conversation) or automatically. For instance, if user 110 expresses a certain amount of negative feelings (e.g., sadness), the AI agent 112 adapts to be more effective in responding to be empathic and uplifting.

Similarly, the feedback 136 can be used to improve the paralinguistic service 124, for example, re-train or further train generally for all users or train to develop personalized models for the user 110. The feedback 136 can help the paralinguistic service 124 to better infer the paralinguistic classification 126 from the processed sensor data 120 in the future.

### Sensors

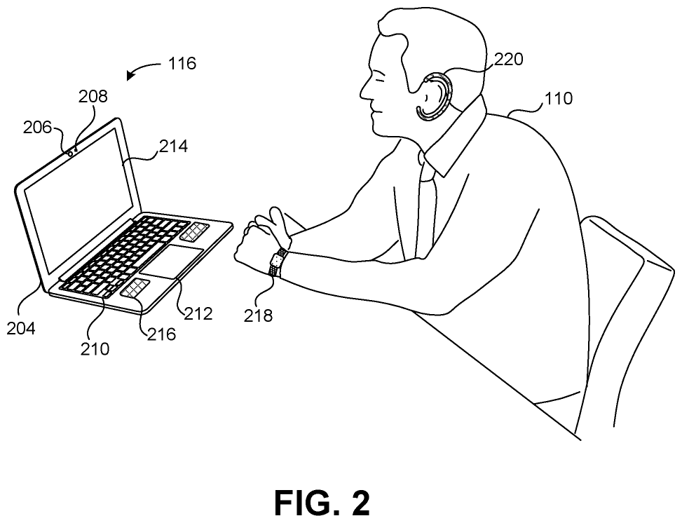

FIG. 2 illustrates an example use of the sensors 116, consistent with some implementations of the present concepts. In this example, the user 110 is using an example user device 111, introduced above in connection with FIG. 1, which is manifest in FIG. 2 as a laptop 204. The laptop 204 includes one or more processors and one or more storages which store executable instructions such as applications. The user 110 can use the laptop 204 for a myriad of purposes, including interacting with the AI agent 112 and/or other users. The user 110 can choose to opt in and have one or more of the sensors 116 detect and measure a certain set of context signals associated with the user 110. The context signals can include physiological signals from the user's body, cognitive signals from the user's mind, environmental signals from the user's surroundings, audio signals including the user's voice, and video signals including a visual of the user's face and body.

For example, the laptop 204 includes example sensors 116 including a camera 206 for capturing video signals. Although FIG. 2 shows only one camera for illustration purposes, the camera 206 can include multiple cameras. The camera 206 can sense the ambient light in the user's environment. The camera 206 can be an infrared camera that measures the user's body temperature. The camera 206 can be a red-green-blue (RGB) camera that functions in conjunction with an image recognition module for eye gaze tracking, measuring pupil dilation, recognizing facial expressions, recognizing gestures, or detecting skin flushing or blushing. The camera 206 can also measure the user's heart rate and/or respiration rate, as well as detect perspiration. The camera 206 can also be a depth-sensing camera that perceives the distance to objects and generates a depth map of the scene.

The laptop 204 includes additional sensors 116 including a microphone 208 for capturing audio signals. The microphone 208 can detect ambient sounds as well as the user's speech. The microphone 208 can function in conjunction with a speech recognition module and/or an audio processing module to detect the words spoken, the user's vocal tone, speech volume, speech speed, pitch, intonation, the source of background sounds, the genre of music playing in the background, etc.

The laptop 204 including additional sensors 116 including a keyboard 210 and a touchpad 212. The user 110 can use the keyboard 210 to input the prompt 114 to the AI agent 112. The keyboard 210 and/or the touchpad 212 can include a finger pulse heart rate monitor. The keyboard 210 and/or the touchpad 212, in conjunction with the laptop's operating system (OS) and/or applications, can detect digital signals including usage telemetry, such as typing rate, clicking rate, scrolling/swiping rate, browsing speed, etc., and also detect the digital focus of the user 110 (e.g., reading, watching, listening, composing, conferencing, multi-tasking, etc.). The OS and/or the applications in the laptop 204 can provide additional digital signals, such as the number of concurrently running applications, processor usage, network usage, network latency, memory usage, disk read and write speeds, etc.

The user 110 can wear the sensors 116 including a smartwatch 218 or any other wearable devices, and permit certain readings to be taken. The smartwatch 218 can measure the user's heart rate, heart rate variability (HRV), perspiration rate (e.g., via a photoplethysmography (PPG) sensor), blood pressure, body temperature, body fat, blood sugar, etc. The smartwatch 218 can include an inertial measurement unit (IMU) that measures the user's motions and physical activities, such as being asleep, sitting, walking, running, jumping, and swimming. The smartwatch 218 can also measure the user's hand or arm gestures.

The user 110 can choose to wear additional sensors 116 including an EEG sensor 220. Depending on the type, the EEG sensor 220 may be worn around the scalp, behind the ear (as shown in FIG. 2), or inside the ear. The EEG sensor 220 includes sensors, such as electrodes, that measure electrical activities of the user's brain.

The example sensors 116 described above output the sensor data 120. The sensor data 120 can include metadata, such as timestamps for each of the measurements, the identity of the user 110 associated with the measurements, session identifiers, sensor device identifiers, etc. The timestamps can provide a timeline of sensor measurements, such as heart rate trends or body temperature trends over time.

The laptop 204 also includes a display 214 for presenting the output 134 to the user 110 via a textual output channel and/or a graphical output channel. The laptop 204 also includes a speaker 216 for presenting the output 134 in an audio output channel.

The above descriptions in connection with FIG. 2 provide a number of example sensors 116 that can measure audio, video, physiological, cognitive, digital, and/or environmental signals associated with the user 110. FIG. 2 includes only a limited number of examples for the purposes of illustration. Other types of sensors and other sensing modalities are possible. The present concepts can use any type of sensor to detect any type of signal that can be used to determine the context. Consistent with some implementations, the sensors 116 can collect signals in real time, such that the user's current state (e.g., the user's immediate reaction) can be determined in real time. Consistent with the present concepts, the sensor data 120 collected by the sensors 116 is processed and fed into the paralinguistic service 124 to determine the paralinguistic classification 126 associated with the user 110.

### Output Channels

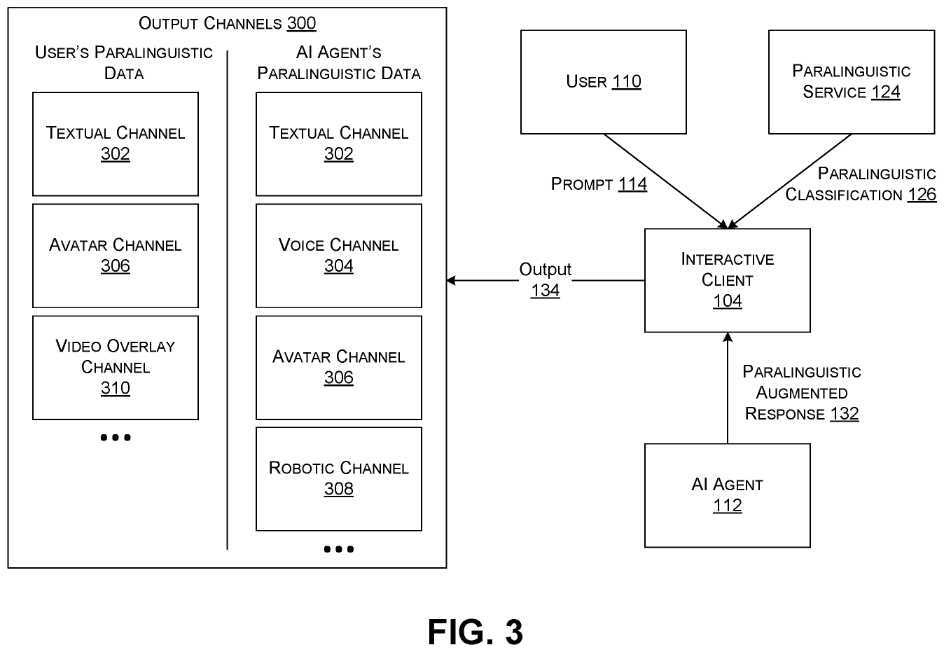

FIG. 3 illustrates example output channels for paralinguistic data included in the output 134, consistent with some implementations of the present concepts. As explained above in connection with FIG. 1, the interactive client 104 receives the prompt 114 from the user 110, the user's paralinguistic data (e.g., the paralinguistic classification 126) from the paralinguistic service 124, and the AI agent's paralinguistic data (included in the paralinguistic augmented response 132) from the AI agent 112. The interactive client 104 generates the output 134 to be presented to the user 110 based on the user's inferred paralinguistic data and/or the AI agent's simulated paralinguistic data. Furthermore, depending on the mode of interaction involving the user 110, the AI agent 112, and/or other users, the interactive client 104 generates the output 134 based one or more of output channels 300. Examples of the output channels 300 for presenting the AI agent's paralinguistic data include a textual channel 302, a voice channel 304, an avatar channel 306, and a robotic channel 308. Examples of the output channels 300 for presenting the user's paralinguistic data include the textual channel 302, the avatar channel 306, and a video overlay channel 310. Other output channels are possible. Moreover, the interactive client 104 chooses one or more representations of paralinguistic data when generating the output 134, which will be presented to the user 110, depending on the output channels 300 being employed.

In one implementation, the AI agent's paralinguistic data can be presented to the user 110 via the textual channel 302. The textual channel 302 can be used when the mode of interaction between the user 110 and the AI agent 112 involves a text-based chat. For example, the AI agent's response can be presented to the user 110 as text (e.g., on the display 214) and the AI agent's paralinguistic data can be presented to the user 110 as markups to the text. That is, the AI agent's paralinguistic data (e.g., simulated affective states) is converted into corresponding text markups. The markups can include any kind of changes or additions to the text, such as capitalization, font type, font size, font color, background color, punctuations, text description of the paralinguistic classification 126, emojis, icons, percentages, etc. More details are given below in connection with subsequent figures.

In another implementation, the AI agent's paralinguistic data can be presented to the user 110 via the voice channel 304. The voice channel 304 can be used when the mode of interaction between the user 110 and the AI agent 112 involves a voice communication (e.g., using speech recognition technology and/or text-to speech technology). For instance, the text of the AI agent's response is converted to speech audio using text-to-speech techniques. Additionally, the speech audio is generated and/or modified based on the AI agent's paralinguistic data. That is, the AI agent's paralinguistic data is converted into corresponding adjustments to the computer-generated speech audio. For example, various features of the speech audio, such as tone, pitch, volume, speed, pause, etc., can be adjusted based on the AI agent's paralinguistic data. If the AI agent 112 is simulating anger, then the speech audio can increase in volume. Or, if the AI agent 112 is simulating nervousness, then the speech audio can decrease in volume and/or increase in pitch. Then, the speech audio is presented to the user 110 (e.g., via the speaker 216). Accordingly, the AI agent's simulated paralinguistic data comes through the speech audio (e.g., the AI agent sounds sad, excited, fearful, etc.).

In another implementation, the AI agent's paralinguistic data can be presented to the user 110 via the avatar channel 306. The avatar channel 306 can be used when the mode of interaction between the user 110 and the AI agent 112 involves a computer-generated avatar representation of the AI agent 112. The avatar can be a still image, a moving video, or a three-dimensional object. The avatar can include a face, an upper body, or an entire body. For instance, the avatar can be presented via a graphical interface on the display 214, and the avatar's simulated speech can be played via the speaker 216. Similar to the voice channel 304 described above, presenting the output 134 through the avatar channel 306 includes presenting the speech audio to the user 110, where the speech audio is generated based on the text of the AI agent's response as well as the AI agent's paralinguistic data. Additionally, the appearance of the avatar's face, mouth, and lips depends on the AI agent's response, such that the avatar appears to be speaking the text of the AI agent's response via automated, computer-generated lip-synchronization and facial expressions. Further, the AI agent's paralinguistic data is converted into corresponding facial expressions, body language, and/or gestures of the avatar. For example, the avatar can be made to smile with its mouth, open its eye wider, and raise its eyebrows when the AI agent 112 is simulating happy emotions. Accordingly, the AI agent's simulated paralinguistic data is apparent to the user 110 both auditorily and visually.

In another implementation, the AI agent's paralinguistic data can be presented to the user 110 via the robotic channel 308. The robotic channel 308 can be used when the mode of interaction between the user 110 and the AI agent 112 involves a robotic interface. For example, a robot can include a head with a face, or an entire body with arms, hands, legs, etc. Similar to the avatar channel 306 described above, presenting the output 134 through the robotic channel 308 includes presenting speech audio, mouth movements, facial expressions, and bodily language to the user 110. However, instead of presenting a graphical representation of an avatar, the robot physically conveys the output 134 to the user 110 using voice and non-verbal cues. In this implementation, the AI agent's paralinguistic data is converted into corresponding physical movements of the robot (e.g., via pneumatic actuators and/or servo motors that move artificial muscles) to mimic human facial expressions, body language, and/or gestures. Further, the AI agent's response is converted into corresponding movement of the robot's face, mouth, jaws, cheeks, and lips to mimic the appearance that the robot is speaking the AI agent's response. For instance, the Facial Action Coding System (FACS) can be used to program the paralinguistic data into facial movement sequences, such as puckering the lips or raising the cheeks.

In one implementation, the user's paralinguistic data (or another user's paralinguistic data) can be presented to the user 110 via the textual channel 302. The textual channel 302 can be used when the user 110 is interacting with the AI agent 112 and/or other users via a text-based chat. Similar to how the AI agent's paralinguistic data is presented to the user 110 via the textual channel 302, as explained above, the user's paralinguistic data is presented to the user 110 as markups to the text (e.g., font style, color, punctuations, emojis, percentages, etc.).

Where the user 110 is presented with her own paralinguistic data, the user 110 is made aware of how her own contextual cues are being interpreted by the paralinguistic service 124, received by the AI agent 112, and/or presented to other users. Accordingly, the user 110 can provide the feedback 136 about the accuracy of the user's paralinguistic data as inferred by the paralinguistic service 124. Moreover, the user 110 can also intentionally adjust the contextual cues that the user 110 is exhibiting. For example, if the user 110 unwittingly exhibits sadness and is made aware by the presented paralinguistic data, then the user 110 can try to hide her sadness to the AI agent 112 and/or other users, if the user 110 so desires.

In another implementation, the user's paralinguistic data (or another user's paralinguistic data) can be presented to the user 110 via the avatar channel 306. The avatar channel 306 can be used when the mode of interaction among the user 110, the AI agent 112, and/or other users involves an avatar representation of the user 110 (or of another user). Similar to how the AI agent's paralinguistic data is presented to the user 110 via the avatar channel 306, as explained above, the user's paralinguistic data (and/or the other user's paralinguistic data) is presented to the user 110 auditorily and visually using an avatar. For instance, an avatar that represents the user 110 is presented to the other user in the interaction, and an avatar that represents the other user is presented to the user 110. Additionally, the avatar representing the user 110 can also be displayed to the user 110 herself, so that she can see how her own avatar is being presented to the other user.

If the user's original speech audio is available, because the mode of interaction involves the user 110 speaking, then the user's original speech audio can simply be played back to the other user. Thus, the user's avatar will appear to be speaking. And the user's speech audio includes contextual cues (e.g., the original intonations, pitch, speed, etc.). If the user's original speech audio is unavailable, because the mode of interaction did not involve the user 110 speaking (e.g., the user 110 input text), then the interactive client 104 generates the output 134 to include synthesized speech audio using text-to-speech techniques. Similar to the voice channel 304 described above, the synthesized speech audio is generated based on the user's paralinguistic data with respect to, for example, tone, pitch, speech, volume, pause, etc.

If a video recording of the user 110 is available, because the mode of interaction involves the user 110 being recorded by the camera 206, then the visual features of the user 110 in the video recording (e.g., facial expressions, body language, hand gestures, etc.) can be replicated by the user's avatar. If a video recording of the user 110 is unavailable, then the interactive client 104 generates the output 134 to include a visual representation of the user's avatar that is based on the user's paralinguistic data. That is, the user's paralinguistic data is converted into corresponding facial expressions, body language, and/or gestures for the user's avatar. Similar techniques can be applied to generating an avatar that represents the other user to be presented to the user 110, and optionally to the other user as well.

In another implementation, the user's paralinguistic data (or another user's paralinguistic data) can be presented to the user 110 via a video overlay channel 310. The video overlay channel 310 can be used when the mode of interaction among the user 110, the AI agent 112, and/or other users involves presenting a live video recording (or an avatar representation) of the user 110 (or of another user). For example, the mode of interaction can include a videoconference where a live video stream of the user 110 (which includes audio recording and video images) is presented to the other user. Additionally, the user's paralinguistic data is presented to the other user as an overlay on top of the video images of the user 110 being presented to the other user. The video overlay can include a graphical representation (possibly including a textual representation) of the user's paralinguistic data. Similar techniques can be applied to presenting a video overlay of the other user's paralinguistic data on top of the video recording of the other user to the user 110.

Although various examples of the output channels 300 for presenting paralinguistic data to the user 110 have been described above individually, in some implementations, multiple output channels can be used in combination. Moreover, other output channels, in addition to the examples of the output channels 300 discussed above in connection with FIG. 3, are possible. For example, a haptic channel can be used to deliver shaking vibrations to present angry emotions. As another example, a lighting channel can be used to present brighter lighting (e.g., ambient light or display brightness) for positive emotions and to present darker lighting for negative emotions. Some of these example output channels 300 will be described further below in reference to subsequent figures.

### Color Coding

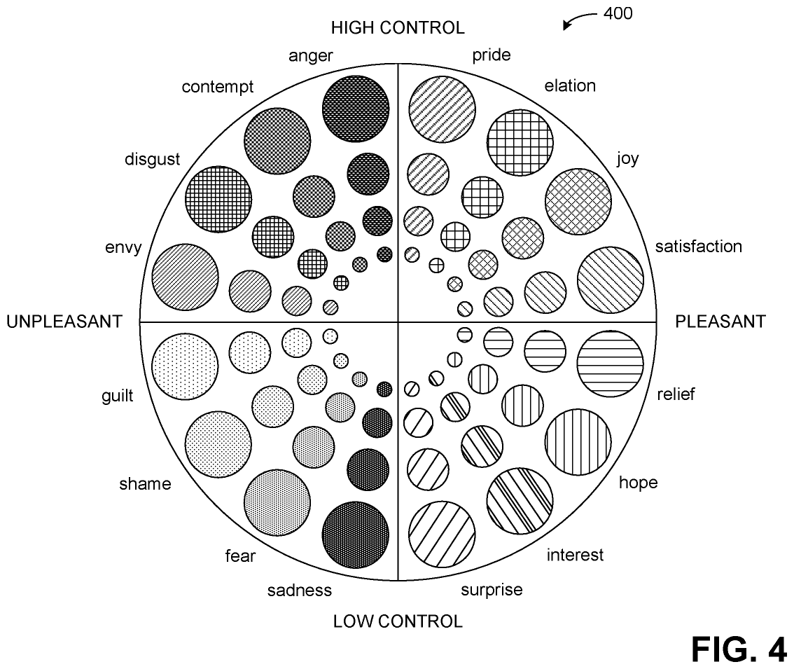

FIG. 4 illustrates example visual coding representations of paralinguistic data, consistent with some implementations of the present concepts. In this case, the visual coding representations are achieved with color coding. FIG. 4 shows a color dial 400 that associates paralinguistic classifications 126 with particular colors (which are shown in FIG. 4 as different black-and-white patterns). The color dial 400 shows that the spectrum of paralinguistic classifications 126 can be multi-dimensional. In this example, the paralinguistic classifications 126 include emotions ranging from pleasant to unpleasant in one dimension and also ranging from high control to low control in another dimension. In one implementation, anger codes to red, envy codes to purple, shame codes to blue, surprise codes to green, satisfaction codes to yellow, and elation codes to orange. Furthermore, the intensity of emotions can be represented by the intensity of the colors. That is, stronger emotions are represented by fuller colors, whereas weaker (i.e., more neutral) emotions are represented by faded or transparent colors. Alternatively, stronger emotions can be represented by bigger colored circles, whereas weaker emotions are represented by smaller colored circles. Other color coding schemes are possible.

In some implementations, the paralinguistic classifications 126 are converted into the corresponding coded colors using the color dial 400, and the coded colors are presented to the user 110. There are many ways to present the coded colors that represent certain paralinguistic data to the user 110. For example, the font color of the text displayed to the user 110 can be the coded color or other visual representation, such as shading or patterns, among others. The coded color can be displayed as the background color behind the text displayed to the user 110 or as a color of a box around the text. The coded color can be displayed as a window color, a window background color, a color filter, etc. Or, the coded color can simply be displayed as a shape or an icon (e.g., a circle, a square, a button, or a flag) of that color to the user 110. Alternatively, the coded color can be overlaid over a video. By presenting the coded color concurrently with the verbal data, the user 110 is made aware of the paralinguistic data.

In some implementations, the visual codes are presented to the user 110, for example, as a legend. In the color coding example, the color dial 400 can be presented to the user 110 or made accessible by the 110 upon demand. For example, if the user 110 is unfamiliar with the color code mappings (e.g., can't remember which emotion the red color represents), then the user 110 can reference the color dial 400 using a graphical user interface. In another implementation, instead of presenting all the color codes by presenting the color dial 400, a subset of the color codes (e.g., the colors that are currently being presented) can be presented to the user 110.

### Emojis and Percentages

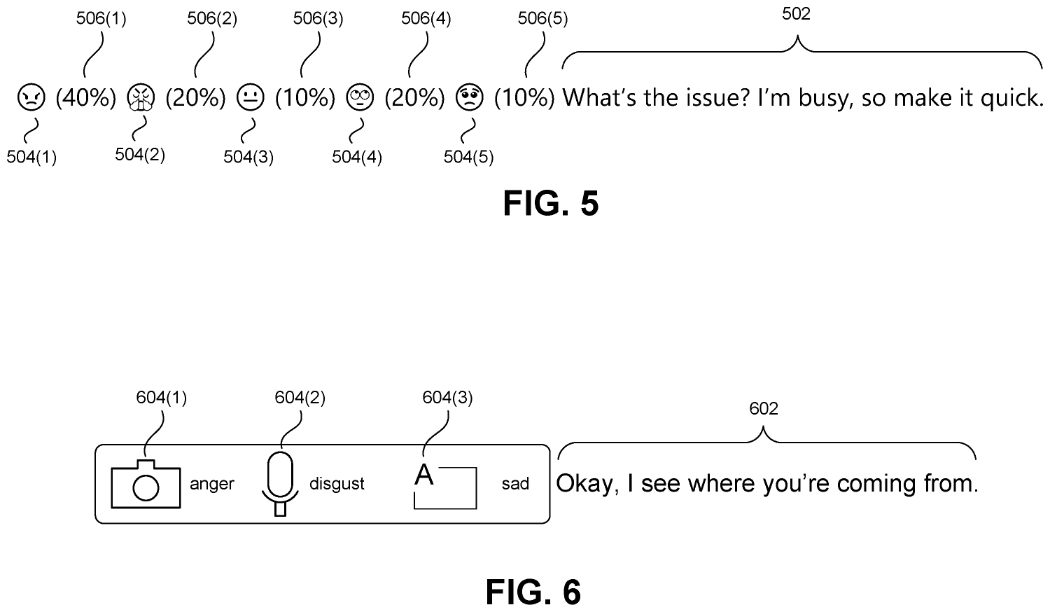

FIG. 5 illustrates example emoji and percentage representations of paralinguistic data, consistent with some implementations of the present concepts. In the example shown in FIG. 5, the output 134 includes verbal data (e.g., text tokens) and paralinguistic data (e.g., paralinguistic tokens). The paralinguistic data in this example includes pairings of paralinguistic classifications 126 and associated weight values (e.g., confidence values). In one implementation, the verbal data is presented to the user 110 as text 502, i.e., “What's the issue? I'm busy, so make it quick.” The text 502 can be displayed to the user 110 on the display 214. The text 502 shown in FIG. 5 can be the prompt 114 input by the user 110 (via typing or speaking), a verbal input from another to be sent to the user 110, or a response provided by the AI agent 112 (included in the paralinguistic augmented response 132).

The paralinguistic data is converted into corresponding emojis 504 and percentages 506. That is, the paralinguistic classifications 126 are converted into the corresponding emojis 504, and the weight values are converted into the percentages 506. In this example, the paralinguistic data has been converted into an angry emoji 504(1), a frustration emoji 504(2), a fear emoji 504(3), an annoyance emoji 504(4), and a sadness emoji 504(5). Additionally, the paralinguistic data has been converted into a set of percentages 506 corresponding to the five emojis 504. In one implementation, the percentages 506 can represent confidence levels of the inferred paralinguistic classifications 126. In another implementation, the percentages 506 can represent relative weights of the inferred or simulated emotions. The paralinguistic data presented in FIG. 5 can be the paralinguistic classifications 126 associated with the user 110 and inferred by the paralinguistic service 124, paralinguistic classifications associated with another user inferred by the paralinguistic service 124, or simulated paralinguistic classifications associated with the AI agent 112 (included in the paralinguistic augmented response 132). The paralinguistic data (in the form of the emojis 504 and the percentages 506) is presented to the user 110 in real time concurrently with the verbal data (in the form of the text 502).

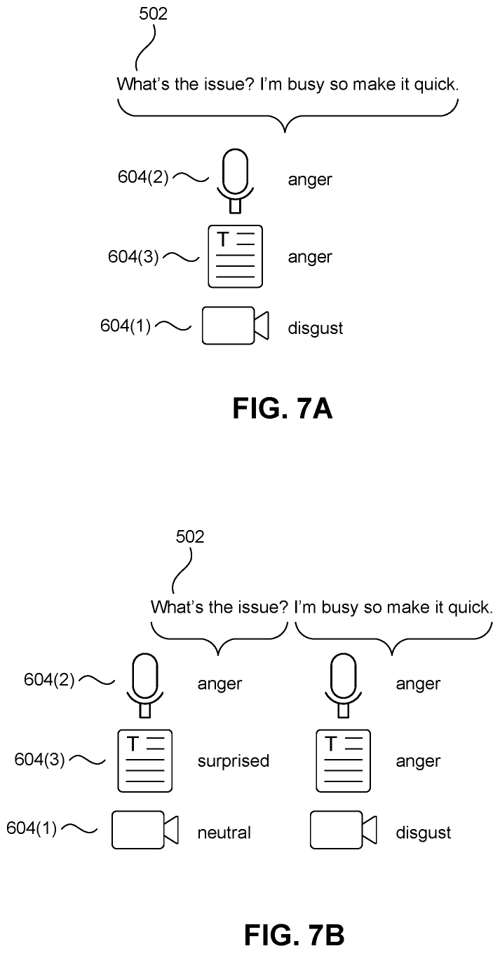

The example in FIG. 5 presents the paralinguistic data (e.g., the emojis 504 and the percentages 506) before (i.e., left of) the verbal data (e.g., the text 502). In another implementation, the paralinguistic data is presented after (i.e., right of), under (as shown in FIGS. 7A and 7B), over, or in the middle of the verbal data. In another implementation, the presented paralinguistic data can be associated with a specific part of the presented verbal data, rather than the entire presented verbal data. That is, the emojis 504 and the percentages 506 can be presented in association with only a part of the text 502. In another implementation, the paralinguistic data is presented as a set of the emojis 504 (without the percentages 506). Similarly, in another implementation, the paralinguistic data is presented as a set of the percentage 506 with corresponding text descriptions of the paralinguistic classifications 126 (without the emojis 504).

### Sensory Modalities

FIG. 6 illustrates example sensory modalities associated with paralinguistic data, consistent with some implementations of the present concepts. In the example shown in FIG. 6, the output 134 includes verbal data and paralinguistic data. In one implementation, the verbal data is presented to the user 110 as text 602, i.e., “Okay, I see where you're coming from.” The text 602 can be displayed to the user 110 on the display 214. In this example, the paralinguistic data includes paralinguistic classifications 126 for separate sensory modalities: anger from video, disgust from audio, and sadness from text. That is, the paralinguistic service 124 inferred from the processed sensory data 120 that the video exhibits anger, the audio exhibits disgust, and the text (e.g., the prompt 114) exhibits sadness. Accordingly, the paralinguistic data is converted into pairings of icons 604 representing the sensory modalities and text descriptions of emotions. In FIG. 6, a camera icon 604(1) represents the video sensory modality, a microphone icon 604(2) represents the audio sensory modality, and a textbox icon 604(3) represents the textual sensory modality. The paralinguistic data (including the icons 604 and the text descriptions) is presented in real time to the user 110 concurrently with the verbal data (including the text 602). In addition to the example shown in FIG. 6, many other examples are possible. Various icons can be used to represent other sensory modalities, such as thermometer, EEG sensor, heart rate sensor, PPG sensor, etc.

### Text Tokens

FIGS. 7A and 7B illustrate example paralinguistic data associated with text tokens, consistent with some implementations of the present concepts. Both figures show a textual representation of verbal data, i.e., text 502. The text 502 include one or more text tokens, where a text token can comprise a word, multiple words, a punctuation, or other characters. Both figures also show representations of paralinguistic data. In these examples, the representations of the paralinguistic data include the camera icon 604(1), the microphone icon 604(2), and the textbox icon 604(3) representing the video sensory modality, the audio sensory modality, and the textual sensory modality, respectively, along with corresponding text descriptions of the paralinguistic classifications 126 (e.g., “anger,” “disgust,” and “neutral”) for each of the sensory modalities.

In FIG. 7A, the paralinguistic data is associated with the entirety of the text 502. Accordingly, the anger and disgust emotions are concurrent with the entire period associated with the text 502. As such, the paralinguistic data is presented in association with the entirety of the text 502. In contrast, in FIG. 7B, the paralinguistic data is associated with parts of the text 502. Associated with the beginning part of the text 502 (i.e., “What's the issue?”) are anger from audio, surprised from text, and neutral from video. Associated with the ending part of the text 502 (i.e., “I'm busy so make it quick.”) are anger from audio, anger from text, and disgust from video. In the example shown in FIG. 7B, the paralinguistic data is associated with a specific part (e.g., specific text tokens) of the verbal data. Accordingly, the paralinguistic data is presented in association with specific part of the text 502. Different levels of granularity or specificity are possible, where paralinguistic data is associated with shorter or longer strings of text (i.e., fewer or greater number of text tokens).

### Video Overlay

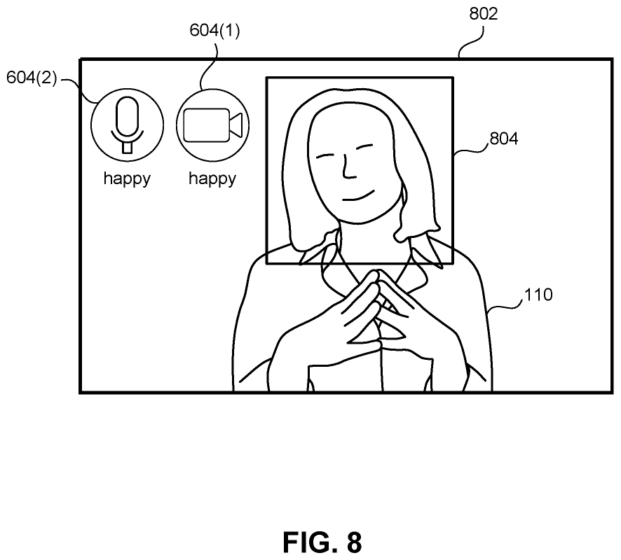

FIG. 8 illustrates example paralinguistic data presented as a video overlay, consistent with some implementations of the present concepts. In FIG. 8, a window 802 shows the user 110. The window 802 can be part of a videoconferencing application that includes other windows for showing other participants in a live videoconference. The window 802 displays the video of the user 110 captured by the camera 206. The window 802 can be presented to the user 110 on the display 214 so that the user 110 can see herself during the videoconference. Additionally, the window 802 is displayed to other participants in the videoconference so that the other participants can see the user 110. In an alternative implementation, the window 802 shows a live video capture of another participant in the videoconference. As such, an audio capture of the other participant's speech (i.e., the verbal data) is presented to the user 110 via the speaker 216. In another implementation, the window 802 presents an avatar that represents the user 110, another user, or the AI agent 112.

In the example shown in FIG. 8, the paralinguistic data has been converted to the camera icon 604(1) associated with happy emotion and the microphone icon 604(2) associated with happy emotion. In one implementation, the paralinguistic data presented to the user 110 as a video overlay on top of the live video capture being displayed in the window 802. The paralinguistic data (e.g., the icons 604) can be presented to the user 110 concurrently with the verbal data (e.g., speech recording). Although FIG. 8 shows the camera icon 604(1) and the microphone icon 604(2), other forms of the paralinguistic data can be presented as a video overlay in the window 802. For example, the colors described above in connection with FIG. 4, the emojis 504 described above in connection with FIG. 5, and/or the percentages 506 described above in connection with FIG. 5 can be presented in the window 802 as video overlays.

In one implementation, the window 802 includes a highlight 804. The highlight 804 can be a box (as shown in FIG. 8) but other forms of highlighting are possible, such as circle or any other shape, a zone having different brightness or contrast, a zoomed portion, an arrow, etc. The highlight 804 highlights one or more underlying causes of the paralinguistic inferences. For example, if the paralinguistic service 124 inferred the paralinguistic data (i.e., that the user 110 is happy in this example) based primarily on the user's facial expressions, then the highlight 804 can emphasize the user's face in the window 802.

In one use case scenario, the window 802 includes the user 110 and is presented to the user 110 herself. Therefore, the paralinguistic data overlaid on top of the video capture of herself in the window 802 includes the paralinguistic classifications 126 associated with the user 110 herself that were inferred by the paralinguistic service 124 based on the sensor data 120 taken from the user 110. Accordingly, the user 110 is made aware, in real time, of her own contextual cues that she is currently exhibiting, the paralinguistic data that were determined by the paralinguistic service 124, and the paralinguistic data that was input to the AI agent 112.

In another use case scenario, the window 802 includes a video capture of another user and is presented to the user 110. With the permission of the other user, the paralinguistic data overlaid on top of the video capture of the other user in the window 802 and presented to the user 110 includes paralinguistic classifications associated with the other user that were inferred based on sensor data taken from the other user. Accordingly, the user 110 is made aware, in real time, of the contextual cues that the other user is exhibiting, as determined by the paralinguistic service 124, even if the user 110 herself is unable to pick up on such contextual cues.

In another use case scenario, the window 802 displays an avatar representing the AI agent 112 and the simulated paralinguistic data associated with the AI agent 112 is overlaid in the window 802. Therefore, the user 110 is made aware, in real time, of the simulated paralinguistic data associated with the AI agent 112 through the overlaid paralinguistic data, which can replace, supplement, and/or validate any contextual cues (e.g., vocal intonations, facial expressions, body language, gestures, etc.) exhibited by the avatar.

### Combinations

Although many aspects and features of the present concepts have been described individually above, they can be implemented in combinations. For example, the various representations of paralinguistic data described above (e.g., colors, font styles, emojis, percentages, sensory modalities, text token associations, video overlays, etc.) can be utilized together. Similarly, the various output channels described above (e.g., textual, voice, avatar, robotic, video overlay, haptic, lighting, etc.) can be utilized in combination.

### Computer Environment

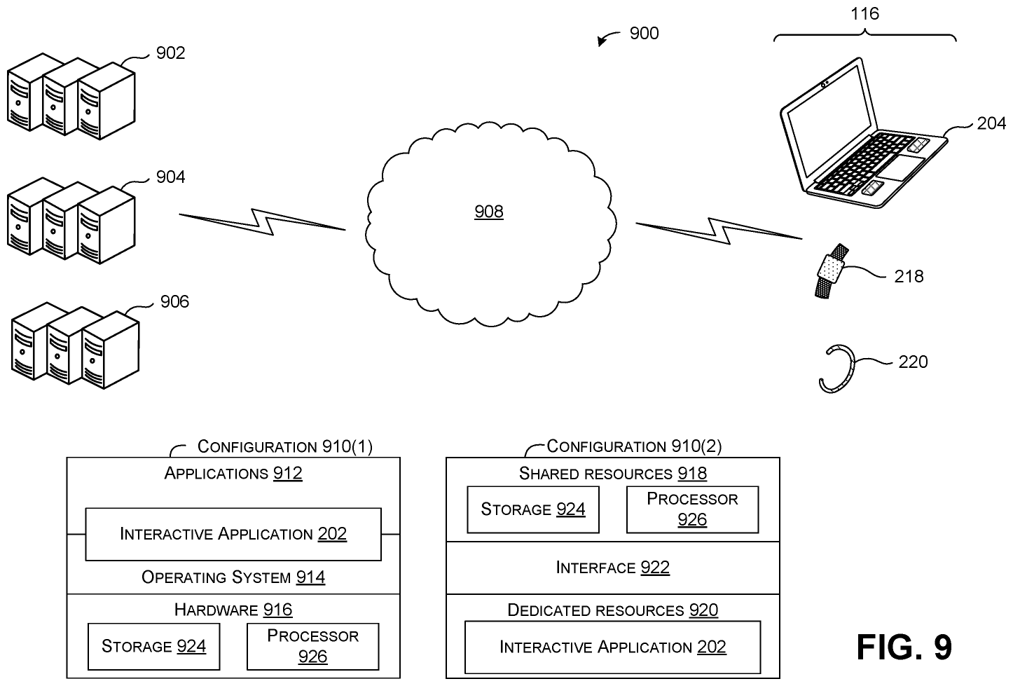

FIG. 9 illustrates an example computer environment 900, consistent with some implementations of the present concepts. The computer environment 900 includes the sensors 116 for taking measurements and/or collecting the sensor data 120 associated with the user 110. For example, the laptop 204 includes the camera 206, the microphone 208, the keyboard 210, the touchpad 212, the touchscreen display 214, an operating system, and applications. If the user 110 opts in, the laptop 204 can capture video data (e.g., facial expression, pupil dilation, hand and arm gestures, etc.), audio data (e.g., speech, background noise, etc.), physiological data (e.g., heart rate), digital data (e.g., application focus, typing rate, clicking rate, scrolling rate, etc.), and/or environmental data (e.g., ambient light) associated with the user 110. The smartwatch 218 includes biosensors for capturing physiological data (e.g., heart rate, respiration rate, perspiration rate, motion activities, etc.). The EEG sensor 220 measures cognitive data (e.g., brain activity) of the user 110. The sensors 116 shown in FIG. 9 are mere examples. Many other types of sensors can be used to take various readings that relate to or affect the paralinguistic states of the user 110.

The sensor data 120 is transferred to an interactive application server 902, which includes the interactive application 102, through a network 908. The user 110 inputs the prompt 114 via the laptop 204, and the laptop 204 sends the prompt 114 to the interactive application server 902 via the network 908. The network 908 can include multiple networks (e.g., Wi-Fi, Bluetooth, NFC, infrared, Ethernet, etc.) and may include the Internet. The network 908 can be wired and/or wireless.

The interactive application server 902 takes the sensor data 120 from the sensors 116 (and optionally performs pre-processing on the sensor data 120) and sends the sensor data 120 to a paralinguistic server 904, which includes the paralinguistic service 124, through the network 908. The paralinguistic server 904 includes machine-learning models that predict the user's paralinguistic classifications 126 based on the sensor data 120. The paralinguistic server 904 transmits the predicted paralinguistic classifications 126 to the interactive application server 902 through the network 908. The interactive application server 902 augments the prompt 114 based on the predicted paralinguistic classifications 126 and feeds the paralinguistic augmented prompt 130 to an AI server 906, which includes the AI agent 112, via the network 908. In turn, the AI server 906 transmits the paralinguistic augmented response 132 to the interactive application server 902 via the network 908. The interactive application server 902 then generates the output 134 and transmits the output 134 to the laptop 404 through the network 908 to be presented to the user 110.

In one implementation, each of the interactive application server 902, the paralinguistic server 904, and the AI server 906 includes one or more server computers. These server computers can each include one or more processors and one or more storage resources. These server computers can perform different functions or can be load-balanced to perform the same or shared functions. The interactive application server 902, the paralinguistic server 904, and the AI server 906 can be located on the same server computer or on different server computers, and can be physical servers or virtual servers. In one implementation, the interactive application server 902, the paralinguistic server 904, and/or the AI server 906 run one or more services (e.g., cloud-based services) that can be accessed via application programming interfaces (APIs) and/or other communication protocols (e.g., hypertext transfer protocol (HTTP) calls). Although FIG. 9 depicts the interactive application server 902, the paralinguistic server 904, and the AI server 906 as server computers, their functionality or some parts of their functionality may be implemented on edge computers and/or client computers, such as the laptop 204, a desktop computer, a smartphone, a tablet, etc.

FIG. 9 also shows two example device configurations 910 of a server computer, such as the interactive application server 902. The first device configuration 910(1) represents an operating system (OS) centric configuration. The second device configuration 910(2) represents a system on chip (SoC) configuration. The first device configuration 910(1) can be organized into one or more applications 912, an operating system 914, and hardware 916. The second device configuration 910(2) can be organized into shared resources 918, dedicated resources 920, and an interface 922 therebetween.

The device configurations 910 can include a storage 924 and a processor 926. The device configurations 910 can also include the interactive application 202.

As mentioned above, the second device configuration 910(2) can be thought of as an SoC-type design. In such a case, functionality provided by the device can be integrated on a single SoC or multiple coupled SoCs. One or more processors 926 can be configured to coordinate with shared resources 918, such as storage 924, etc., and/or one or more dedicated resources 920, such as hardware blocks configured to perform certain specific functionality.

The term “device,” “computer,” or “computing device” as used herein can mean any type of device that has some amount of processing capability and/or storage capability. Processing capability can be provided by one or more hardware processors that can execute data in the form of computer-readable instructions to provide a functionality. The term “processor” as used herein can refer to one or more central processing units (CPUs), graphical processing units (GPUs), controllers, microcontrollers, processor cores, or other types of processing devices, which may reside in one device or spread among multiple devices. Data, such as computer-readable instructions and/or user-related data, can be stored on storage, such as storage that can be internal or external to the device. The term “storage” can include any one or more of volatile or non-volatile memory, hard drives, flash storage devices, optical storage devices (e.g., CDs, DVDs etc.), and/or remote storage (e.g., cloud-based storage), among others. As used herein, the term “computer-readable medium” can include transitory propagating signals. In contrast, the term “computer-readable storage medium” excludes transitory propagating signals.

Generally, any of the functions described herein can be implemented using software, firmware, hardware (e.g., fixed-logic circuitry), or a combination of these implementations. The term “component” or “module” as used herein generally represents software, firmware, hardware, whole devices or networks, or a combination thereof. In the case of a software implementation, for instance, these may represent program code that performs specified tasks when executed on one or more processors. The program code can be stored in one or more computer-readable memory devices, such as computer-readable storage media. The features and techniques of the component are platform-independent, meaning that they can be implemented on a variety of commercial computing platforms having a variety of processing configurations.

### Technological Advantages

Conventional interactions between a user and an AI agent involve text-only chat messages, which can often lead to confusion, miscommunication, and misunderstanding. Presenting real-time paralinguistic data associated with the AI agent 112 to the user 110 concurrently with the verbal response from the AI agent 112 has multiple advantages. First, conveying simulated emotions and other contextual cues associated with the AI agent 112 to the user 110 in innate and intuitive ways that the user 110 can easily understand enables a more natural and empathic interaction. Human-to-human communications often involves verbal communication accompanied by emotional contexts. Therefore, presenting the AI agent's verbal response along with the AI agent's simulated paralinguistic data provides more human-like and engaging interactions with the AI agent 112.

Second, the chances of miscommunication and misunderstanding are reduced. The verbal data alone can fail to convey the true, accurate, or full meaning, especially if the intended meaning is sarcastic or joking. Even in other scenarios, many categories of emotions (e.g., happiness, excitement, compassion, fear, and urgency) can be difficult to come through from words alone. Therefore, the accompanying paralinguistic data provides an additional level of communication to enhance the quality of interactions with the AI agent 112.

Third, the concepts described above include several example representations and example output channels for presenting paralinguistic data to the user 110. Furthermore, those representations and output channels can be combined to further enhance the communication of paralinguistic data. Thus, the selection and combinations of various representation and output channels can be custom-tailored to the specific preferences of the user 110 for improved efficacy and user experience.

Fourth, expressly seeing the AI agent's simulated emotions can enable the user 110 to realize more quickly and more accurately what may have triggered those simulated emotions. For example, the user 110 can instruct the AI agent 112 to pretend to be a job interviewer. If the mock interview starts out with positive paralinguistic data from the AI agent 112 but then suddenly the paralinguistic data associated with the AI agent 112 turns negative, the user 110 can better reflect and pinpoint what the user 110 may have said or done to elicit negative simulated emotions from the AI agent 112. Such information can be beneficial in preparing the user 110 for the real interview. Accordingly, the AI agent 112 be used as a more powerful coaching tool.

Furthermore, conventional interactions between human users, whether via chat messages or videoconferences, do not provide any assistance in detecting each other's contextual cues or in being aware of one's own contextual cues. Presenting real-time paralinguistic data associated with the user 110 to the user 110 herself has multiple advantages. First, the user 110 is made aware of her own paralinguistic data that was inferred by the paralinguistic service 124 and fed into the AI agent 112. Therefore, the user 110 can gauge whether the AI agent's response is appropriate. That is, the user 110 can visually see whether the AI agent 112 correctly interpreted the user's contextual cues. For example, if the user 110 exhibits sarcasm, figure of speech, or body language that is the opposite of verbal speech, then the user 110 will know whether the AI agent 112 successfully picked up on the contextual cues.

Second, by explicitly presenting the user's own paralinguistic data, the user 110 can provide feedback on the quality (e.g., accuracy) of the paralinguistic inferences. Such feedback can be used to enhance the paralinguistic service 124 and/or the AI agent 112 through re-training and/or personalized training. Enhancing the machine-learning models employed by the paralinguistic service 124 and/or the AI agent 112 will improve future interactions with the AI agent 112.

Third, presenting the user 110 with her own paralinguistic data in real time allows the user 110 to confirm that contextual cues the user 110 wants to exhibit are being exhibited and that contextual cues the user does not want to exhibit are not being exhibited. Additionally, the user 110 could be alerted if contextual cues she wants to hide are being exhibited or if contextual cues she wants to exhibit are not being exhibited. People in general are not always aware of the contextual cues that they are externally exhibiting, nor are they always able to control the contextual cues that they display. The self-awareness provided by these concepts allows the user 110 to intentionally try to change her contextual cues.

For example, the user 110 initiates a videoconference with work colleagues and needs to announce a new project that is challenging and difficult but wants to spin it in a positive light. The presentation of the user's paralinguistic data-confirming that the user 110 is exhibiting happiness, excitement, and interest-ensures the user 110 that she is exhibiting the contextual cues that she wants to exhibit to her coworkers. As another example, the user 110 instructs the AI agent 112 to roleplay her boss while the user 110 and the AI agent 112 conduct a mock meeting where the user 110 asks for a raise in her salary. The user 110 wants to maintain composure regardless of her boss's reaction (i.e., the AI agent's response). If the presentation of the user's paralinguistic data indicates that the user 110 is starting to exhibit anger, frustration, and contempt, then the user 110 can catch her own contextual cues and perhaps consciously try to hide such unproductive display of emotions. Therefore, the paralinguistic system 100 can be used as a tool for the user 110 to be more self-conscious and to check how her own contextual cues come across to the AI agent 112 and/or other users.

Moreover, presenting real-time paralinguistic data associated with another user to the user 110 has multiple advantages as well. People in general have lifelong experience in picking up on other people's contextual cues. However, people can sometimes fail to detect contextual cues of others or can even misinterpret other people's contextual cues for a multitude of reasons. The contextual cues may be subtle, the contextual cues may contradict verbal data, the listener may not be in tune with the speaker's contextual cues, the listener could be distracted, or the speaker may be unable to fully express contextual cues due to disability, illness, drowsiness, etc.

First, presenting paralinguistic data associated with another user in real time enables the user 110 to immediately confirm and validate the contextual cues that the user 110 picked up on, whether consciously or subconsciously. For example, if the user 110 believes the other user might be angry but isn't certain, expressly asking the other user, “are you angry?” could escalate the anger even further. Instead, using the paralinguistic system 100, the user 110 would be presented with the other user's paralinguistic data, confirming that the other user is indeed angry, so that the user 110 can be made aware and respond more tactfully.

Second, paralinguistic data of the other user presented to the user 110 can alert the user 110 to contextual cues that she failed to pick up on. For example, the other user may say, “I'm fine,” trying to hide his true feelings, to the user 110, and the user 110 may believe the other user. However, the paralinguistic system 100 detects and immediately presents the paralinguistic data of the other user as worry and fear. Such additional information allows the user 110 to respond more sympathetically and compassionately.

Third, the paralinguistic system 100 can be a very useful tool for medical reasons. Some people with autism (e.g., Asperger syndrome) may experience difficulties in expressing their own emotions as well as recognizing other people's emotions. The paralinguistic system 100 can provide a social interactive platform that assists such people in handling contextual cues. Also, patients who are ill, weak, recovering from anesthesia, or under the influence of certain drugs can find it hard to show their emotions, for example, on their faces or through speech and gestures. Further, it is especially critical that certain medical professionals, such as psychiatrists, psychologists, and therapists, are made aware of their patients' emotional states in order to provide accurate diagnoses and prescribe effective treatments. In these scenarios, the paralinguistic system 100 can serve as a useful tool (e.g., a videoconferencing application with paralinguistic features for telemedicine) that informs the user 110 in real time of the other user's paralinguistic data.

### Additional Examples

Various examples are described above. Additional examples are described below. One example includes a computer-implemented method, comprising receiving a paralinguistic augmented response from an artificial intelligence (AI) agent, the paralinguistic augmented response including textual data and paralinguistic data, the paralinguistic augmented response being generated by the AI agent in response to a prompt from a user during a real-time conversation between the user and the AI agent and outputting the textual data and the paralinguistic data to be presented concurrently to the user during the real-time conversation.

Another example can include any of the above and/or below examples where the paralinguistic data includes paralinguistic classifications and the method further comprises converting the paralinguistic classifications into corresponding colors and outputting the textual data along with the corresponding colors.

Another example can include any of the above and/or below examples where the paralinguistic data includes paralinguistic classifications and the method further comprises converting the paralinguistic classifications into corresponding emojis and outputting the textual data along with the corresponding emojis.

Another example can include any of the above and/or below examples where the paralinguistic data includes paralinguistic classifications and corresponding percentages and the method further comprises outputting the textual data along with descriptions of the paralinguistic classifications and the corresponding percentages.

Another example can include any of the above and/or below examples where the textual data includes a plurality of word tokens, the paralinguistic data is associated with one of the plurality of word tokens.

Another example can include any of the above and/or below examples where the method further comprises converting the textual data to speech audio based on the paralinguistic data, where the paralinguistic data determines at least one of tone, volume, speed, pitch, or pause of the speech audio, and where outputting the textual data and the paralinguistic data includes outputting the speech audio.

Another example can include any of the above and/or below examples where the method further comprises generating an avatar, where the paralinguistic data is converted to at least one of a facial expression, a body language, or a gesture of the avatar, where outputting the paralinguistic data includes outputting the avatar.

Another example can include any of the above and/or below examples where the method further comprises converting the paralinguistic data to a robotic movement that corresponds to at least one of a facial expression, a body language, or a gesture, where outputting the paralinguistic data includes outputting the robotic movement.

Another example includes a system comprising a processor and a storage including computer-readable instructions which, when executed by the processor, cause the processor to receive a prompt from a user during a real-time conversation involving the user, receive paralinguistic data associated with the user from a paralinguistic service that inferred the paralinguistic data, and output the paralinguistic data to be presented to the user concurrently with the prompt during the real-time conversation.

Another example can include any of the above and/or below examples where the paralinguistic data is associated with sensory modalities.

Another example can include any of the above and/or below examples where the computer-readable instructions further cause the processor to convert the sensory modalities to corresponding icons that represent the sensory modalities.

Another example can include any of the above and/or below examples where the computer-readable instructions further cause the processor to present a live video capture of the user to the user and present the corresponding icons overlaid on the live video capture to the user.

Another example can include any of the above and/or below examples where the computer-readable instructions further cause the processor to receive feedback from the user, the feedback rating the paralinguistic data.

Another example can include any of the above and/or below examples where the paralinguistic data includes paralinguistic classifications and corresponding percentages.

Another example includes a computer-readable storage medium storing instructions which, when executed by a processor, cause the processor to receive verbal data from a first user during an interaction involving the first user and a second user, receive paralinguistic data associated with the first user from a paralinguistic service in real time during the interaction, and output the verbal data and the paralinguistic data to be presented concurrently to the second user during the interaction.

Another example can include any of the above and/or below examples where the paralinguistic data includes paralinguistic classifications associated with sensory modalities.

Another example can include any of the above and/or below examples where the sensory modalities include at least two of video, audio, or text.

Another example can include any of the above and/or below examples where the instructions further cause the processor to present a live video capture of the first user to the second user and present icons representing the sensory modalities and the associated paralinguistic classifications overlaid on the live video capture to the second user.

Another example can include any of the above and/or below examples where the paralinguistic data includes paralinguistic classifications associated with percentages.

Another example can include any of the above and/or below examples where the instructions further cause the processor to convert the paralinguistic classifications into emojis and present the emojis and the associated percentages concurrently with the verbal data to the second user.

1. A computer-implemented method, comprising:
receiving a paralinguistic augmented response from an artificial intelligence (AI) agent, the paralinguistic augmented response including textual data and paralinguistic data, the paralinguistic augmented response being generated by the AI agent in response to a prompt from a user during a real-time conversation between the user and the AI agent; and
outputting the textual data and the paralinguistic data to be presented concurrently to the user during the real-time conversation.

2. The computer-implemented method of claim 1, wherein:
the paralinguistic data includes paralinguistic classifications; and
the method further comprises:
converting the paralinguistic classifications into corresponding colors; and
outputting the textual data along with the corresponding colors.

3. The computer-implemented method of claim 1, wherein:
the paralinguistic data includes paralinguistic classifications; and
the method further comprises:
converting the paralinguistic classifications into corresponding emojis; and
outputting the textual data along with the corresponding emojis.

4. The computer-implemented method of claim 1, wherein:
the paralinguistic data includes paralinguistic classifications and corresponding percentages; and
the method further comprises:
outputting the textual data along with descriptions of the paralinguistic classifications and the corresponding percentages.

5. The computer-implemented method of claim 1, wherein the textual data includes a plurality of word tokens, the paralinguistic data is associated with one of the plurality of word tokens.

6. The computer-implemented method of claim 1, further comprising:
converting the textual data to speech audio based on the paralinguistic data,
wherein the paralinguistic data determines at least one of tone, volume, speed, pitch, or pause of the speech audio, and
wherein outputting the textual data and the paralinguistic data includes outputting the speech audio.

7. The computer-implemented method of claim 1, further comprising:
generating an avatar, wherein the paralinguistic data is converted to at least one of a facial expression, a body language, or a gesture of the avatar,
wherein outputting the paralinguistic data includes outputting the avatar.

8. The computer-implemented method of claim 1, further comprising:
converting the paralinguistic data to a robotic movement that corresponds to at least one of a facial expression, a body language, or a gesture,
wherein outputting the paralinguistic data includes outputting the robotic movement.

9. A system, comprising:
a processor;
a storage including computer-readable instructions which, when executed by the processor, cause the processor to:
receive a prompt from a user during a real-time conversation involving the user;
receive paralinguistic data associated with the user from a paralinguistic service that inferred the paralinguistic data; and
output the paralinguistic data to be presented to the user concurrently with the prompt during the real-time conversation.

10. The system of claim 9, wherein the paralinguistic data is associated with sensory modalities.

11. The system of claim 10, wherein the computer-readable instructions further cause the processor to:
convert the sensory modalities to corresponding icons that represent the sensory modalities.

12. The system of claim 11, wherein the computer-readable instructions further cause the processor to:
present a live video capture of the user to the user; and
present the corresponding icons overlaid on the live video capture to the user.

13. The system of claim 9, wherein the computer-readable instructions further cause the processor to:
receive feedback from the user, the feedback rating the paralinguistic data.

14. The system of claim 9, wherein the paralinguistic data includes paralinguistic classifications and corresponding percentages.

15. A computer-readable storage medium storing instructions which, when executed by a processor, cause the processor to:
receive verbal data from a first user during an interaction involving the first user and a second user;
receive paralinguistic data associated with the first user from a paralinguistic service in real time during the interaction; and
output the verbal data and the paralinguistic data to be presented concurrently to the second user during the interaction.

16. The computer-readable storage medium of claim 15, wherein the paralinguistic data includes paralinguistic classifications associated with sensory modalities.

17. The computer-readable storage medium of claim 16, wherein the sensory modalities include at least two of video, audio, or text.

18. The computer-readable storage medium of claim 16, wherein the instructions further cause the processor to:
present a live video capture of the first user to the second user; and
present icons representing the sensory modalities and the associated paralinguistic classifications overlaid on the live video capture to the second user.

19. The computer-readable storage medium of claim 15, wherein the paralinguistic data includes paralinguistic classifications associated with percentages.

20. The computer-readable storage medium of claim 19, wherein the instructions further cause the processor to:
convert the paralinguistic classifications into emojis; and
present the emojis and the associated percentages concurrently with the verbal data to the second user.
